(19) United States
(12) Patent Application Publication
(10) Pub. No.: US 2025/0047126 A1
(43) Pub. Date: Feb. 6, 2025

(54) CHARGING SYSTEM, BACKUP POWER SOURCE SYSTEM, AND MOVING OBJECT

(71) Applicant: Panasonic Intellectual Property Management Co., Ltd., Osaka (JP)

(72) Inventors: Yo KUMODA, Osaka (JP); Shohei YAMANAKA, Osaka (JP)

(73) Assignee: Panasonic Intellectual Property Management Co., Ltd., Osaka (JP)

(21) Appl. No.: 18/716,836

(22) PCT Filed: Nov. 28, 2022
(86) PCT No.: PCT/JP2022/043709

§ 371 Date: Jun. 6, 2024

(30) Foreign Application Priority Data
Dec. 7, 2021 (JP) 2021-198714

(51) Int. Cl. H02J 7/34; B60R 16/033; H02J 7/00

(52) U.S. Cl. CPC H02J 7/34; B60R 16/033; H02J 7/0047; H02J 7/0068; H02J 7/007182

(57) ABSTRACT

A charging system supplies a charge current from a power supply to a power storing apparatus. A shunt resistor is connected to a charging path through which the charge current flows. An amplifier is configured to amplify a voltage across the shunt resistor. A controller is configured to control the charging circuit on a basis of an output from the amplifier. A power supplying circuit is configured to supply a drive voltage to the amplifier. The power supplying circuit includes a first feed path including a diode connected between an input terminal and a power supply terminal of the amplifier and a second feed path including a switch connected between the power storing apparatus and the power supply terminal of the amplifier. The switch is configured to be turned on when a charge voltage of the power storing apparatus exceeds a threshold voltage.

### TECHNICAL FIELD

The present disclosure relates to charging systems, backup power source systems, and moving objects. More specifically, the present disclosure relates to a charging system for charging a power storage, a backup power source system, and a moving object.

### BACKGROUND ART

Patent Literature 1 discloses a power storing device electrically connected between a main power supply and a load, the power storing device being configured to: charge a power storage by a charging circuit in the case of a non-failure of the main power supply; and supply electric power from the power storage via a discharge circuit to the load in the case of a failure of the main power supply.

The power storing device of the Patent Literature 1 includes a charge current detector, a step-up circuit, and a selection circuit. The charge current detector includes: a shunt resistor connected between the charging circuit and the power storage; and an operational amplifier having input terminals connected to both ends of the shunt resistor, and the charge current detector detects a charge current to be supplied to the power storage. The step-up circuit increases a charge voltage of the power storage. The selection circuit includes: a first selection diode connected between the step-up circuit and the operational amplifier; and a second selection diode connected between the main power supply and the operational amplifier. The selection circuit outputs a higher one of a voltage of the main power supply and an output voltage of the step-up circuit as a drive voltage for the operational amplifier.

In the power storing device of Patent Literature 1, the output voltage of the step-up circuit is supplied as the drive voltage to the operational amplifier when the voltage of the main power supply decreases. Therefore, the step-up circuit thus disposed leads to the problem that the entire circuit of the power storing device has an increased size.

### CITATION LIST

### Patent Literature

Patent Literature 1: JP 2010-178528 A

### SUMMARY OF INVENTION

It is an object of the present disclosure to provide a charging system, a backup power source system, and a moving object which include a downsized circuit.

A charging system of an aspect of the present disclosure includes an input terminal, a charging circuit, a shunt resistor, an amplifier, a controller, and a power supplying circuit. The input terminal is connected to a power supply. The charging circuit is connected between the input terminal and a power storing apparatus to supply a charge current from the power supply to the power storing apparatus. The shunt resistor is connected to a charging path through which the charge current flows. The amplifier is configured to amplify a voltage across the shunt resistor and output the voltage thus amplified. The controller is configured to control the charging circuit on the basis of an output from the amplifier. The power supplying circuit is configured to supply a drive voltage to the amplifier. The power supplying circuit includes: a first feed path including a diode connected between the input terminal and a power supply terminal of the amplifier; and a second feed path including a switch connected between the power storing apparatus and the power supply terminal of the amplifier. The switch is configured to be turned on when a charge voltage of the power storing apparatus exceeds a threshold voltage.

A backup power source system of an aspect of the present disclosure includes the charging system, an output terminal to which a load is to be connected, and a discharge circuit. The discharge circuit is configured to supply electric power from the power storing apparatus via the output terminal to the load when the power supply is in a failure state.

A moving object of an aspect of the present disclosure includes the backup power source system and a moving object body. On the moving object body, the backup power source system, the power supply, and the load are mounted.

### BRIEF DESCRIPTION OF DRAWINGS

FIG. 1 is a schematic circuit diagram of a backup power source system according to an embodiment of the present disclosure;

FIG. 2 is a specific circuit diagram of the backup power source system;

FIG. 3 is a graph of a change in a voltage of each of components included in the backup power source system with time;

FIG. 4 is a graph of a change in a voltage of each of components included in a backup power source system of a comparative example with time;

FIG. 5 is a graph of the change in the voltage of each of the components included in the backup power source system of the embodiment of the present disclosure with time;

FIG. 6 is a schematic illustrative view of a moving object including the backup power source system of the embodiment of the present disclosure;

FIG. 7 is a schematic circuit diagram of a backup power source system including a charging system according to a first variation; and

FIG. 8 is a schematic circuit diagram of a backup power source system according to a second variation.

### DESCRIPTION OF EMBODIMENTS

### Embodiment

An embodiment of a charging system, a backup power source system, and a moving object will be described below. The drawings to be referred to in the following description of the embodiment are all schematic representations. Thus, the ratio of the dimensions (including thicknesses) of respective constituent elements illustrated on the drawings does not always reflect their actual dimensional ratio.

### (1) Overview

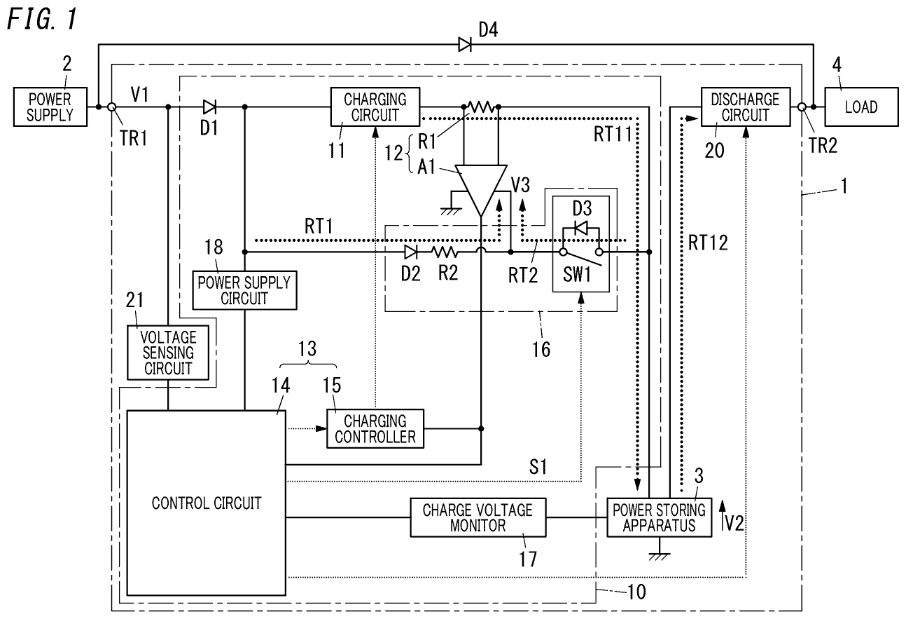

As shown in FIG. 1, a charging system 10 of the present embodiment includes an input terminal TR1, a charging circuit 11, a shunt resistor R1, an amplifier A1, a controller 13, and a power supplying circuit 16.

To the input terminal TR1, a power supply 2 is to be connected.

The charging circuit 11 is connected between the input terminal TR1 and a power storing apparatus 3. The charging circuit 11 supplies a charge current from the power supply 2 to the power storing apparatus 3.

The shunt resistor R1 is connected to a charging path RT11 through which the charge current flows.

The amplifier A1 amplifies a voltage across the shunt resistor R1 and outputs the voltage thus amplified.

The controller 13 controls the charging circuit 11 on the basis of an output from the amplifier A1.

The power supplying circuit 16 supplies a drive voltage to the amplifier A1. The power supplying circuit 16 includes: a first feed path RT1 including a diode D2 connected between the input terminal TR1 and a power supply terminal of the amplifier A1; and a second feed path RT2 including a switch SW1 connected between the power storing apparatus 3 and the power supply terminal of the amplifier A1.

The switch SW1 is turned on when a charge voltage V2 of the power storing apparatus 3 exceeds a threshold voltage Vth. Note that the switch SW1 may be referred to as a first switch in the following description.

When the charge voltage V2 of the power storing apparatus 3 is lower than the threshold voltage Vth, a voltage V1 of the power supply 2 is supplied via the first feed path RT1 to the power supply terminal of the amplifier A1. When the power storing apparatus 3 is not charged such that the charge voltage V2 reaches the threshold voltage Vth, the drive voltage is supplied from the power supply 2 to the amplifier A1, and therefore, the output from the amplifier A1 stabilizes, which enables the controller 13 to stably control the charging circuit 11 on the basis of the output from the amplifier A1.

Here, if no second feed path RT2 is provided, charging the power storing apparatus 3, in a state where the drive voltage is supplied from the power supply 2 to the amplifier A1, until the charge voltage V2 exceeds the threshold voltage Vth and then stopping supplying electric power from the power supply 2 result in a decrease in the drive voltage to the amplifier A1 to zero. Meanwhile, to the input terminal of the amplifier A1, a voltage substantially equal to the charge voltage V2 of the power storing apparatus 3 is input, which leads to a state in which a voltage significantly higher than the drive voltage is input to the amplifier A1. In the charging system 10 of the present embodiment, the switch SW1 is turned on when the charge voltage V2 of the power storing apparatus 3 exceeds the threshold voltage Vth, so that the charge voltage V2 of the power storing apparatus 3 is input to the power supply terminal of the amplifier A1 via the switch SW1. This reduces, in the case of the supplying electric power from the power supply 2 being stopped, a differential voltage between the drive voltage input to the power supply terminal of the amplifier A1 and an input voltage, which avoids a situation in which an excessively high input voltage is input to the amplifier A1, thereby protecting the amplifier A1.

Moreover, in the charging system 10 of the present embodiment, the second feed path RT2 includes the switch SW1, and the second feed path RT2 enables the charge voltage V2 of the power storing apparatus 3 to be supplied to the power supply terminal of the amplifier A1 via the switch SW1. Thus, there is the advantage that as compared with the case where a step-up circuit configured to increase the charge voltage V2 of the power storing apparatus 3 is provided to supply a voltage increased by the step-up circuit to the power supply terminal of the amplifier A1, omitting the step-up circuit downsizes the circuit.

Moreover, the charging system 10 of the present embodiment is applied to a backup power source system 1 configured to supply electric power from the power storing apparatus 3 to a load 4 when the power supply 2 is in a failure state.

The backup power source system 1 includes the charging system 10, an output terminal TR2 to which the load 4 is to be connected, and a discharge circuit 20.

The discharge circuit 20 supplies electric power from the power storing apparatus 3 via the output terminal TR2 to the load 4 when the power supply 2 is in the failure state.

Moreover, between the power supply 2 and the load 4, a diode D4 is connected in parallel to the backup power source system 1.

In a non-failure state in which the power supply 2 is not in failure, electric power is supplied from the power supply 2 via the diode D4 to the load 4. In contrast, in the failure state in which the power supply 2 is in failure, the discharge circuit 20 supplies electric power from the power storing apparatus 3 via the output terminal TR2 to the load 4. Thus, also when the power supply 2 is in the failure state, the load 4 can be supplied with the electric power so that the load 4 can operate. The backup power source system 1 includes the charging system 10 and thus has the advantage that the circuit is downsized.

As used herein, the failure state in which the power supply 2 is in failure means a state in which a breakdown or deterioration of the power supply 2, a disconnection of a power supply line, or the like stops supplying electric power from the power supply 2 to the load 4. The non-failure state in which the power supply 2 is not in failure means a state in which electric power is supplied from the power supply 2 to the load 4, and the load 4 is operable with the electric power supplied from the power supply 2.

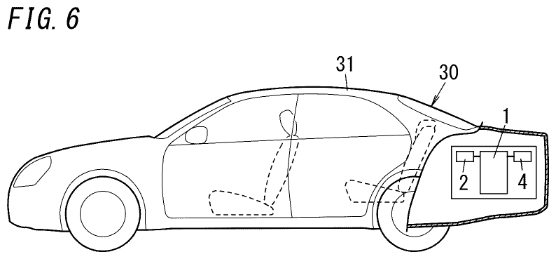

Moreover, the backup power source system 1 is mounted on, for example, a moving object such as a vehicle 30 (see FIG. 6). That is, the moving object includes the backup power source system 1 and a moving object body 31 (e.g., a vehicle body of the vehicle 30). On the moving object body 31, the backup power source system 1, the power supply 2, and the load 4 are mounted. When a failure of the power supply 2 of the vehicle 30 (e.g., a battery of the vehicle 30) occurs, the backup power source system 1 supplies electric power from the power storing apparatus 3 to the load 4 (e.g., an electrically driven brake system). Thus, also when a failure of the power supply 2 occurs, the load 4 can continue operating by using the electric power supplied from the power storing apparatus 3.

Note that FIG. 6 is a schematic diagram of the vehicle 30 on which the backup power source system 1 is mounted, and in the vehicle body of the vehicle 30, locations of the backup power source system 1, the power supply 2, and the load 4 are not limited to those shown in FIG. 6 but may accordingly be changed.

An aspect in which the charging system 10 is included in the backup power source system 1 will be described below as an example, but the charging system 10 is not limited to being included in the backup power source system 1 but may be applied to a system which only charges the power storing apparatus 3.

Moreover, an example in which the backup power source system 1 is mounted on the vehicle 30 is shown below, but the moving object is not limited to the vehicle 30 but may be aircraft, watercraft, a railway train, or the like. Moreover, the backup power source system 1 is not limited to being mounted on the moving object but may be installed in a facility or the like.

### (2) Details

Referring to FIGS. 1 to 5, the charging system 10 of the present embodiment and the backup power source system 1 including the charging system 10 will be described in detail below.

### (2.1) Configuration

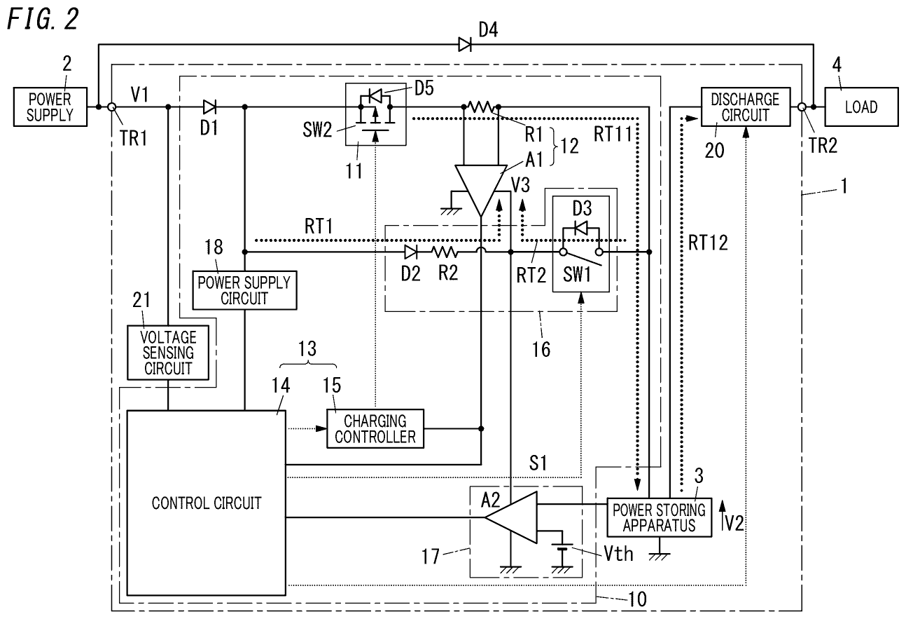

FIG. 2 is a circuit diagram showing a specific configuration of the charging circuit 11 and a charge voltage monitor 17 in the backup power source system 1 of FIG. 1.

As described above, the charging system 10 includes the input terminal TR1, the charging circuit 11, the shunt resistor R1, the amplifier A1, the controller 13, and the power supplying circuit 16. Note that the controller 13 includes: a control circuit 14 configured to control, for example, the entirety of the backup power source system 1; and a charging controller 15 configured to control the charging circuit 11 on the basis of a current command value received from the control circuit 14 and the output from the amplifier A1. Moreover, the charging system 10 further includes the charge voltage monitor 17 (see FIG. 1) and a power supply circuit 18.

As described above, the backup power source system 1 includes the charging system 10, the output terminal TR2, and the discharge circuit 20. Moreover, the backup power source system 1 further includes a voltage sensing circuit 21.

Each of a plurality of components included in the charging system 10 and the backup power source system 1 will be described below.

The charging system 10 is used to charge the power storing apparatus 3. The power storing apparatus 3 is, for example, an electrical double layer capacitor (EDLC) capable of fast charging and discharging. The power storing apparatus 3 may include two or more power storing devices (e.g., electrical double layer capacitors) electrically connected in parallel or series to each other. Moreover, the power storing apparatus 3 may include a plurality of electricity storing modules including a plurality of power storing devices (e.g., electrical double layer capacitors) electrically connected in series to each other, the plurality of electricity storing modules being connected in parallel to each other. That is, the power storing apparatus 3 may be implemented as a parallel circuit or a series circuit of two or more power storing devices, or a combination of the parallel circuit and the series circuit. In the present embodiment, the charging system 10 includes the power storing apparatus 3, but it is not essential that the charging system 10 includes the power storing apparatus 3. The power storing apparatus 3 disposed outside the charging system 10 may be charged by the charging system 10.

To the input terminal TR1, the power supply 2 is connected. The power supply 2 is, for example, a battery of the vehicle 30. Note that to the power supply 2, an anode of the diode D4 is connected, and a cathode of the diode D4 is connected to the load 4. When the power supply 2 is in the non-failure state, electric power is supplied from the power supply 2 via the diode D4 to the load 4. Note that the power supply 2 is connected between the input terminal TR1 and a ground potential of the backup power source system 1 and the charging system 10, and the load 4 is connected between the output terminal TR2 and the ground potential of the backup power source system 1 and the charging system 10.

Between the input terminal TR1 and the charging circuit 11, a diode D1 for backflow prevention is connected. The diode D1 prevents a current from flowing from the power storing apparatus 3 toward the power supply 2 when the power supply 2 is in the failure state.

The load 4 is to be connected to the output terminal TR2. The load 4 is, for example, an electrically driven brake system mounted on the vehicle 30. Note that the load 4 is not limited the electrically driven brake system but may be a control-system or drive-system device relating to advanced driver-assistance systems (ADAS).

The charging circuit 11 controls, in accordance with a control signal received from the charging controller 15, the charge current flowing to the power storing apparatus 3. The charging circuit 11 includes a second switch SW2 connected between the diode D1 and the shunt resistor R1. The second switch SW2 is, for example, a p-channel metal-oxide-semiconductor field-effect transistor (MOSFET). The second switch SW2 has a source connected to the diode D1, and the second switch SW2 has a drain connected to the shunt resistor R1. The charging controller 15 controls the second switch SW2, for example, in an active region, thereby controlling the charge current flowing to the power storing apparatus 3.

The power supplying circuit 16 supplies the drive voltage to the power supply terminal of the amplifier A1 via a feed path which is the first feed path RT1 or the second feed path RT2.

The amplifier A1 is, for example, a full-range operational amplifier and can normally operate also when a voltage substantially equal to the drive voltage is input to the amplifier A1.

The first feed path RT1 includes a series circuit of the diode D2 and a current restricting resistor R2 connected between a cathode of the diode D1 and the power supply terminal of the amplifier A1. That is, the charging system 10 further includes the current restricting resistor R2 connected in series to the diode D1 in the first feed path RT1. When the first switch SW1 is in an on state and the voltage V1 of the power supply 2 is higher than the charge voltage V2 of the power storing apparatus 3, the current restricting resistor R2 restricts a current flowing from the power supply 2 via the first feed path RT1 and the second feed path RT2 to the power storing apparatus 3. This can suppress a large current from flowing from the power supply 2 to the power storing apparatus 3, thereby protecting the power storing apparatus 3. The possibility is also reduced that an excessively supplied electric power from the power supply 2 causes a failure of the power supply 2 or a variation in the voltage V1 of the power supply 2.

The second feed path RT2 includes the first switch SW1 connected between the power storing apparatus 3 and the power supply terminal of the amplifier A1. The first switch SW1 is implemented by, for example, a semiconductor switch such as a field effect transistor including a parasitic diode D3. The parasitic diode D3 is connected in an orientation such that a current flows from the power storing apparatus 3 to the power supply terminal of the amplifier A1. The first switch SW1 is controlled to be on or off depending on a switching signal S1 input from the control circuit 14.

The charge voltage monitor 17 monitors a voltage value of the charge voltage V2 of the power storing apparatus 3. The charge voltage monitor 17 includes a comparator A2 configured to compare, for example, the charge voltage V2 of the power storing apparatus 3 and the threshold voltage Vth with each other in terms of a magnitude relationship. The comparator A2 outputs a binary sensing signal depending on the magnitude relationship between the charge voltage V2 and the threshold voltage Vth. If the charge voltage V2 is lower than or equal to the threshold voltage Vth, the charge voltage monitor 17 outputs, for example, a sensing signal having a low signal level to the control circuit 14. If the charge voltage V2 is higher than the threshold voltage Vth, the charge voltage monitor 17 outputs, for example, a sensing signal having a high signal level to the control circuit 14. Note that the charge voltage monitor 17 may sense the voltage value of the charge voltage V2 of the power storing apparatus 3 and output a sensing result of the voltage value to the control circuit 14.

Here, the threshold voltage Vth is lower than a lower limit value of a voltage variation range when the power supply 2 is in the non-failure state. In the vehicle 30, the voltage value of the power supply 2 may vary in accordance with an operational state or the like of the load 4. In the non-failure state, the voltage value of the power supply 2 is allowed to vary within a prescribed voltage variation range. Thus, the threshold voltage Vth is set to a value lower than the lower limit value of the voltage variation range, more specifically, to a voltage lower than a voltage obtained by subtracting a voltage drop across the diodes D1 and D2 and the current restricting resistor R2 from the lower limit value of the voltage variation range. When the charge voltage V2 of the power storing apparatus 3 exceeds the threshold voltage Vth, the first switch SW1 is turned on. When the first switch SW1 is in the on state, the drive voltage can be supplied from the power storing apparatus 3 to the amplifier A1, and therefore, the drive voltage which is higher than the threshold voltage Vth can be supplied to the amplifier A1, thereby stably operating the amplifier A1.

The comparator A2 of the charge voltage monitor 17 is operated with the drive voltage supplied from the power supplying circuit 16 in a similar manner to the amplifier A1. That is, the power supplying circuit 16 supplies the drive voltage also to the charge voltage monitor 17, and therefore, even in the case of the supplying electric power from the power supply 2 being stopped, supplying the drive voltage from the power storing apparatus 3 to the charge voltage monitor 17 enables the charge voltage monitor 17 to operate. Note that the circuit configuration of the charge voltage monitor 17 is an example and may accordingly be modified.

The discharge circuit 20 includes a switch connected, for example, between the power storing apparatus 3 and the output terminal TR2. Turning on/off of the switch of the discharge circuit 20 is controlled by, for example, the control circuit 14.

The voltage sensing circuit 21 senses a voltage value of the voltage V1 input to the input terminal TR1 from the power supply 2 and outputs a sensing result to the control circuit 14.

The control circuit 14 determines, based on the sensing result by the voltage sensing circuit 21, such that when the voltage V1 of the power supply 2 is higher than or equal to a prescribed failure sensing voltage, the power supply 2 is in the non-failure state in which the power supply 2 is not in failure, and the control circuit 14 causes the charging circuit 11 to charge the power storing apparatus 3. The control circuit 14 determines, based on the sensing result by the voltage sensing circuit 21, such that when the voltage V1 of the power supply 2 is lower than the failure sensing voltage, the power supply 2 is in the failure state in which the power supply 2 is in failure, and the control circuit 14 stops charging operation of the charging circuit 11 and turns on the switch of the discharge circuit 20. At this time, electric power is supplied from the power storing apparatus 3 via the discharge circuit 20 to the load 4.

The control circuit 14 determines, for example, based on the voltage value of the charge voltage V2 sensed by the charge voltage monitor 17, the current value of the charge current and outputs the current command value representing the current value of the charge current to the charging controller 15. The charging controller 15 controls, based on the current command value received from the control circuit 14 and the output from the amplifier A1, the charge current to be supplied from the charging circuit 11 to the power storing apparatus 3. The output from the amplifier A1 is proportional to the magnitude of a current flowing through the shunt resistor R1.

Moreover, the control circuit 14 controls turning on/off of the first switch SW1 on the basis of a monitoring output of the charge voltage monitor 17. For example, when the charge voltage V2 of the power storing apparatus 3 exceeds the threshold voltage Vth, the control circuit 14 controls the first switch SW1 such that the first switch SW1 is turned on. Moreover, for example, when the charge voltage V2 of the power storing apparatus 3 decreases to, or lower than, the threshold voltage Vth, the control circuit 14 controls the first switch SW1 such that the first switch SW1 is turned off.

The control circuit 14 and the charging controller 15 each include, as a main component, a computer system including one or more processors and memory. The processor(s) of the computer system executes a program stored in the memory of the computer system, thereby implementing functions of the control circuit 14 and the charging controller 15. The program may be stored in the memory, may be provided over a telecommunications network such as the Internet, or may be provided as a non-transitory recording medium such as a memory card storing the program. Note that the control circuit 14 and the charging controller 15 are not limited to those implemented by the computer system but may be implemented by an analog circuit.

### (2.2) Operation

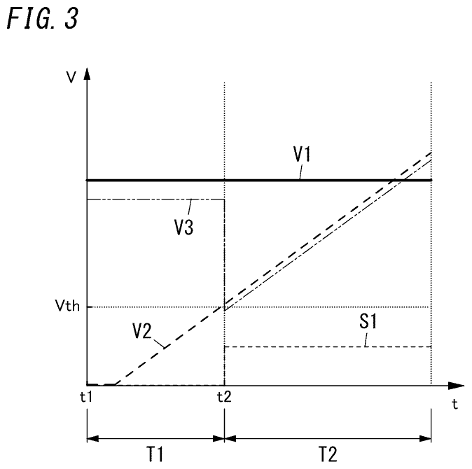

With reference to FIGS. 3 to 5, operation of the charging system 10 and the backup power source system 1 of the present embodiment will be described.

FIG. 3 is a graph showing a change in a voltage of each component with time when the backup power source system 1 is started to be used. In FIG. 3, Vth represents the threshold voltage.

In response to supplying the voltage V1 from the power supply 2 to the backup power source system 1 at a time point t1, the charging circuit 11 charges the power storing apparatus 3, and the charge voltage V2 of the power storing apparatus 3 gradually increases.

Here, during a time period T1 during which the charge voltage V2 is lower than or equal to the threshold voltage Vth, a switching signal S1 having, for example, a low level is input from the control circuit 14 to the first switch SW1, and thus, the first switch SW1 is off. Thus, during the time period T1, the voltage V1 of the power supply 2 is supplied via the first feed path RT1 to the power supply terminal of the amplifier A1. That is, during the time period T1, the drive voltage V3 of the amplifier A1 has a voltage value obtained by subtracting a voltage drop across the diodes D1 and D2 and the current restricting resistor R2 from the voltage V1 of the power supply 2.

Then, when the charge voltage V2 exceeds the threshold voltage Vth at or after a time point t2, a switching signal S1 having, for example, a high level is input from the control circuit 14 to the first switch SW1, and thus, the first switch SW1 is turned on. Thus, during a time period T2 at and after the time point t2, the charge voltage V2 of the power storing apparatus 3 is supplied via the second feed path RT2 to the power supply terminal of the amplifier A1. That is, during the time period T2, the drive voltage V3 of the amplifier A1 has a voltage value obtained by subtracting a voltage drop across the first switch SW1 and the like from the charge voltage V2 of the power storing apparatus 3.

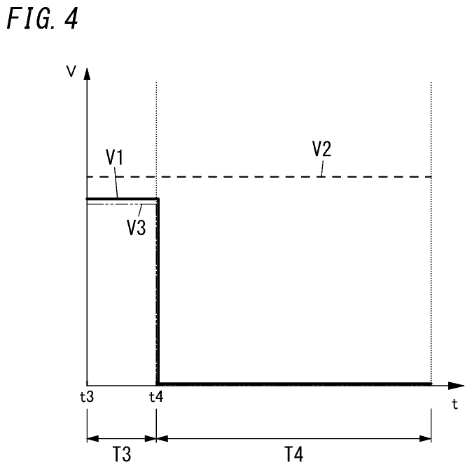

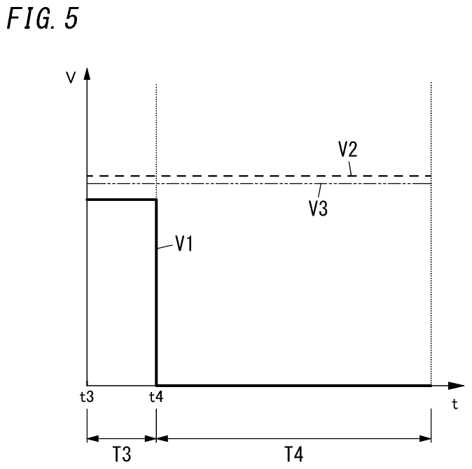

Next, operation in the case where a failure of the power supply 2 occurs after the power storing apparatus 3 is charged will be described with reference to FIGS. 4 and 5.

FIG. 4 shows a change in a voltage of each component of a backup power source system 1 of a comparative example including no second feed path RT2 with time.

A time period T3 from a time point t3 to a time point t4 corresponds to the non-failure state in which the power supply 2 is not in failure. The voltage V1 of the power supply 2 is supplied to the power supply terminal of the amplifier A1, and therefore, during the time period T3, the drive voltage V3 of the amplifier A1 has a voltage value obtained by subtracting a voltage drop across the first feed path RT1 from the voltage V1 of the power supply 2.

When a failure of the power supply 2 occurs at the time point t4, the voltage V1 of the power supply 2 decreases to zero, and the drive voltage V3 of the amplifier A1 thus also decreases to zero. At this time, the charge voltage V2 of the power storing apparatus 3 is applied to the input terminal of the amplifier A1, resulting in that a voltage significantly higher than the drive voltage V3 is applied to the input terminal of the amplifier A1, which leads to a state where an excessively large input voltage is input to the amplifier A1.

Next, operation of the backup power source system 1 of the present embodiment provided with the second feed path RT2 will be described with reference to FIG. 5.

The time period T3 from the time point t3 to the time point t4 corresponds to the non-failure state in which the power supply 2 is not in failure. During the time period T3, the charge voltage V2 of the power storing apparatus 3 is higher than the threshold voltage Vth, and therefore, the first switch SW1 is on, and the charge voltage V2 of the power storing apparatus 3 is supplied via the second feed path RT2 to the power supply terminal of the amplifier A1. Thus, during the time period T3, the drive voltage V3 of the amplifier A1 has the voltage value obtained by subtracting the voltage drop across the first switch SW1 and the like from the charge voltage V2 of the power storing apparatus 3.

When a failure of the power supply 2 occurs at the time point t4, the voltage V1 of the power supply 2 decreases to zero, but the charge voltage V2 of the power storing apparatus 3 is supplied via the second feed path RT2 to the power supply terminal of the amplifier A1. Thus, also during the time period T4, the drive voltage V3 of the amplifier A1 has the voltage value obtained by subtracting the voltage drop across the first switch SW1 and the like from the charge voltage V2 of the power storing apparatus 3. Here, the charge voltage V2 of the power storing apparatus 3 is input to the input terminal of the amplifier A1, but since the full-range operational amplifier is used as the amplifier A1, stable operation is possible even if a voltage substantially equal to the drive voltage V3 is input to the input terminal. Moreover, unlike the backup power source system 1 of the comparative example, no voltage significantly higher than the drive voltage is input to the input terminal of the amplifier A1, which avoids a situation in which an excessively high input voltage is input to the amplifier A1, thereby protecting the amplifier A1.

### (3) Variations

The embodiment described above a mere example of various embodiments of the present disclosure. Various modifications may be made to the embodiment described above depending on design and the like as long as the object of the present disclosure is achieved.

Variations of the embodiment described above will be described below. Any of the variations to be described below may be combined as appropriate.

The charging system 10 and the backup power source system 1 in the present disclosure includes a computer system to implement, for example, the controller 13 (the control circuit 14 and the charging controller 15). The computer system includes a processor and memory as principal hardware components thereof. The processor executes a program stored in the memory of the computer system, thereby implementing functions as the charging system 10 and the backup power source system 1 of the present disclosure. The program may be stored in advance in the memory of the computer system. Alternatively, the program may also be downloaded over a telecommunications network or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memory elements. Thus, the microcontroller may also be implemented as a single or a plurality of electronic circuits including a semiconductor integrated circuit or a large-scale integrated circuit.

Note that the controller 13 is not limited to those implemented by the computer system but may be implemented by an analog circuit.

In the embodiment described above, the functions of the controller 13 are distributed to the control circuit 14 and the charging controller 15 but may be implemented by a single controller.

Moreover, in the embodiment described above, the plurality of components of the backup power source system 1 are integrated together in a single housing. However, this is only an example and is not an essential configuration for the backup power source system 1. Alternatively, these components of the backup power source system 1 may be distributed in multiple different housings. Still alternatively, at least some functions of the backup power source system 1, for example, some functions of the controller 13, may be implemented as a cloud computing system as well. Further, when the backup power source system 1 is mounted on the vehicle 30, some functions of the controller 13 may be implemented by an electronic control unit (ECU) of the vehicle 30.

In the embodiment described above, if one of two values being compared with each other is “greater than” the other, the phrase “greater than” may also be a synonym of the phrase “greater than or equal to”. That is to say, it is arbitrarily changeable, depending on selection of the threshold value or any preset value, whether or not the phrase “greater than” covers the situation where the two values are equal to each other. Therefore, from a technical point of view, there is no difference between the phrase “greater than” and the phrase “greater than or equal to”. Similarly, the phrase “less than or equal to” may be a synonym of the phrase “less than” as well. Therefore, from a technical point of view, there is no difference between the phrase “less than” and the phrase “less than or equal to”.

### (3.1) First Variation

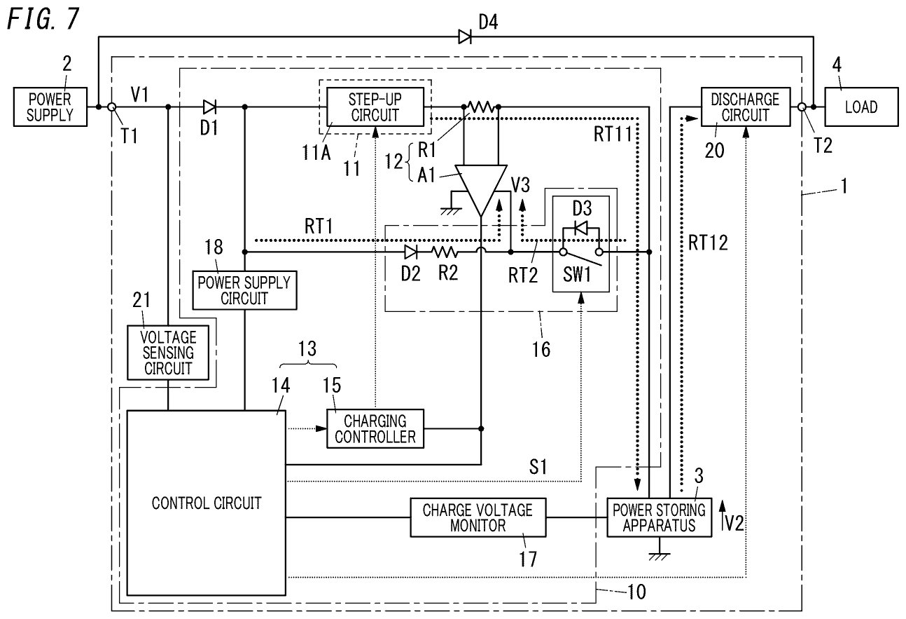

With reference to FIG. 7, a charging circuit 11 in a first variation will be described.

The charging circuit 11 of the first variation is different from the charging circuit 11 of the embodiment described above in that the charging circuit 11 further includes a step-up circuit 11A. Note that components common to those in the embodiment described above are denoted by the same reference signs, and the description thereof will be omitted.

The charging circuit 11 includes the step-up circuit 11A configured to increase the voltage V1 of the power supply 2, and the power storing apparatus 3 is charged with an output from the step-up circuit 11A charges. The step-up circuit 11A is, for example, a step-up chopper circuit but may be a step-up/step-down chopper circuit.

The power storing apparatus 3 is charged with the output of the step-up circuit 11A, and therefore, the power storing apparatus 3 can be charged until the voltage of the power storing apparatus 3 exceeds the voltage V1 of the power supply 2.

### (3.2) Second Variation

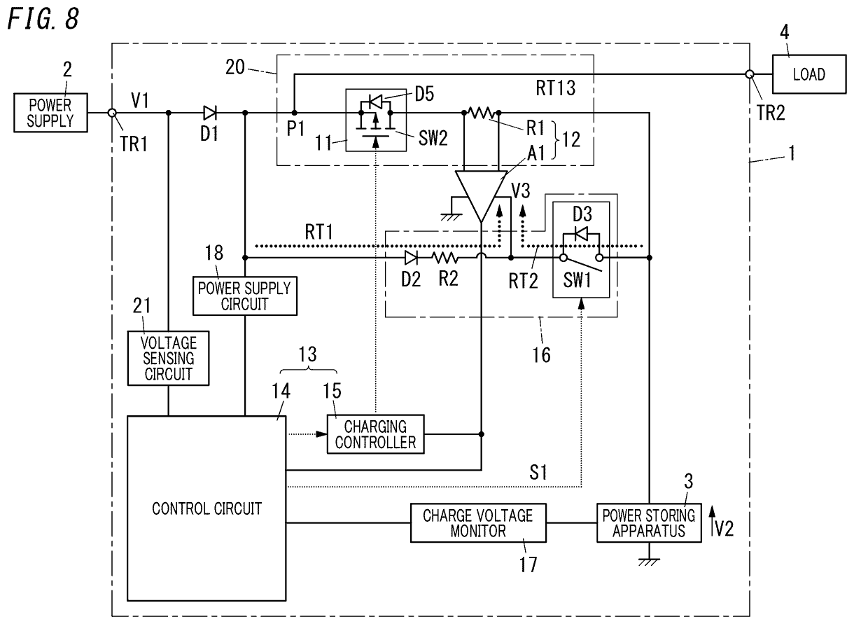

With reference to FIG. 8, a backup power source system 1 of a second variation will be described.

The backup power source system 1 of the second variation includes, in the circuit described above with reference to FIG. 2, a feed path RT13 (see FIG. 8) electrically connecting the output terminal TR2 to a connection point P1 between the input terminal TR1 and the charging circuit 11, and the discharge circuit 20 includes the feed path RT13. Moreover, in the backup power source system 1 of the second variation, the diode D4 connecting the power supply 2 to the load 4 is omitted, and when the power supply 2 is in the non-failure state, electric power is supplied from the power supply 2 via the diode D1 and the feed path RT13 to the load 4. Note that components except for the discharge circuit 20 are similar to those in the backup power source system 1 in the embodiment described above, and therefore, the components common to those in the embodiment are denoted by the same reference signs, and the description thereof will be omitted.

In the backup power source system 1 of the second variation, the control circuit 14 outputs, in response to a failure of the power supply 2, a control signal for causing the second switch SW2 to operate in a saturation region to the charging controller 15, and the charging controller 15 thus operates the second switch SW2 in the saturation region, that is, turns on the second switch SW2. This supplies power to the load 4 via a discharge path going from the power storing apparatus 3 through the shunt resistor R1, the second switch SW2 of the charging circuit 11, and the feed path RT13.

Thus, in the backup power source system 1 of the second variation, the charging circuit 11 includes the second switch SW2 connected between the input terminal TR1 and the power storing apparatus 3, and the second switch SW2 is shared by both the charging circuit 11 and the discharge circuit 20. In the backup power source system 1 of the second variation, the discharge circuit 20 uses the second switch SW2 of the charging circuit 11 to supply electric power to the load 4, and therefore, the configuration of the discharge circuit 20 can be simplified, and thus, the entirety of the circuit can be downsized.

### SUMMARY

As described above, a charging system (10) of a first aspect includes an input terminal (TR1), a charging circuit (11), a shunt resistor (R1), an amplifier (A1), a controller (13), and a power supplying circuit (16). To the input terminal (TR1), a power supply (2) is to be connected. The charging circuit (11) is connected between the input terminal (TR1) and a power storing apparatus (3) to supply a charge current from the power supply (2) to the power storing apparatus (3). The shunt resistor (R1) is connected to a charging path (RT11) through which the charge current flows. The amplifier (A1) is configured to amplify a voltage across the shunt resistor (R1) and output the voltage thus amplified. The controller (13) is configured to control the charging circuit (11) on a basis of an output from the amplifier (A1). The power supplying circuit (16) is configured to supply a drive voltage to the amplifier (A1). The power supplying circuit (16) includes a first feed path (RT1) including a diode (D2) connected between the input terminal (TR1) and a power supply terminal of the amplifier (A1) and a second feed path (RT2) including a switch (SW1) connected between the power storing apparatus (3) and the power supply terminal of the amplifier (A1). The switch (SW1) is configured to be turned on when a charge voltage (V2) of the power storing apparatus (3) exceeds a threshold voltage (Vth).

With this aspect, when the charge voltage (V2) of the power storing apparatus (3) exceeds the threshold voltage (Vth), the switch (SW1) is turned on to supply the charge voltage (V2) of the power storing apparatus (3) via the second feed path (RT2) to the power supply terminal of the amplifier (A1). The second feed path (RT2) includes no step-up circuit for increasing the charge voltage (V2), thereby downsizing the circuit by a size corresponding to the step-up circuit. Moreover, also when supplying electric power from the power supply (2) is stopped in a state where the drive voltage is supplied from the power storing apparatus (3) to the amplifier (A1), an input voltage substantially equal to the drive voltage is input to the amplifier (A1), and therefore, the possibility that an input voltage significantly higher than the drive voltage is input to the amplifier (A1) is reduced, and there is also the advantage that stress applied to the amplifier (A1) can be reduced.

A charging system (10) of a second aspect referring to the first aspect further includes a current restricting resistor (R2) connected in series to the diode (D2) in the first feed path (RT1).

With this aspect, when the switch (SW1) is in an ON state and the voltage of the power supply (2) is higher than the charge voltage (V2), the current restricting resistor (R2) enables a current flowing from the power supply (2) to the power storing apparatus (3) to be reduced.

In a charging system (10) of a third aspect referring to the first or second aspect, the amplifier (A1) includes a full-range operational amplifier in the first feed path (RT1).

With this aspect, when supplying electric power from the power supply (2) is stopped in a state where the drive voltage is supplied from the power storing apparatus (3) to the amplifier (A1), an input voltage substantially equal to the drive voltage is input to the amplifier (A1), but the amplifier (A1) includes the full-range operational amplifier, and therefore, the amplifier (A1) is stably operable.

In a charging system (10) of a fourth aspect referring to any one of the first to third aspects, the charging circuit (11) includes a step-up circuit (11A) configured to increase the voltage (V1) of the power supply (2) to be input to the input terminal (TR1). the power storing apparatus (3) is configured to be charged with an output from the step-up circuit (11A).

This aspect enables the power storing apparatus (3) to be charged until the voltage of the power storing apparatus (3) increases to a voltage obtained by increasing the voltage (V1) of the power supply (2) by the step-up circuit (11A).

In a charging system (10) of a fifth aspect referring to any one of the first to fourth aspects, the threshold voltage (Vth) is lower than a lower limit value of a voltage variation range when the power supply (2) is in a non-failure state.

This aspect enables the amplifier (A1) to be supplied with a drive voltage exceeding the threshold voltage (Vth).

A charging system (10) of a sixth aspect referring to any one of the first to fifth aspects further includes a charge voltage monitor (17) configured to monitor a voltage value of the charge voltage (V2) of the power storing apparatus (3). The controller (13) is configured to turn on the switch (SW1) on a basis of a monitoring output from the charge voltage monitor (17) when the charge voltage (V2) exceeds the threshold voltage (Vth).

This aspect enables the amplifier (A1) to be supplied with a drive voltage exceeding the threshold voltage (Vth).

In a charging system (10) of a seventh aspect referring to the sixth aspect, the power supplying circuit (16) is configured to supply the drive voltage also to the charge voltage monitor (17).

With this aspect, also when supplying electric power from the power supply (2) is stopped, the charge voltage monitor (17) is stably operable.

A backup power source system (1) of an eighth aspect includes the charging system (10) of any one of the first to seventh aspects, an output terminal (TR2) to which a load (4) is to be connected, and a discharge circuit (20). The discharge circuit (20) is configured to supply electric power from the power storing apparatus (3) via the output terminal (TR2) to the load (4) when the power supply (2) is in a failure state.

This aspect enables the backup power source system (1) which is downsized to be provided.

A backup power source system (1) of a ninth aspect referring to the eighth aspect further includes a power storing apparatus (3).

This aspect enables the backup power source system (1) which is downsized to be provided.

In a backup power source system (1) of a tenth aspect referring to the eighth or ninth aspect, the switch (SW1) is a first switch (SW1). The charging circuit (11) includes a second switch (SW2) connected between the input terminal (TR1) and the power storing apparatus (3). The discharge circuit (20) includes a feed path (RT13) connecting the output terminal (TR2) to a connection point (P1) between the input terminal (TR1) and the charging circuit (11). The second switch (SW2) is shared by the discharge circuit (20) and the charging circuit (11).

With this aspect, the discharge circuit (20) and the charging circuit (11) share the second switch (SW2), and thereby, further downsizing is achieved.

A moving object (30) of an eleventh aspect includes the backup power source system (1) of any one of the eighth to tenth aspects, and a moving object body (31). On the moving object body (31), the backup power source system (1), the power supply (2), and the load (4) are mounted.

This aspect enables the moving object (30) including the backup power source system (1) which is downsized to be provided.

The configurations of the second to seventh aspects are not essential configurations for the charging system (10) and may therefore be omitted accordingly. The configurations of the ninth and tenth aspects are not essential configurations for the backup power source system (1) and may therefore be omitted accordingly.

### REFERENCE SIGNS LIST

1 Backup Power Source System
2 Power Supply
3 Power Storing Apparatus
4 Load
10 Charging System
11 Charging Circuit
11A Step-Up Circuit
13 Controller
16 Power Supplying Circuit
17 Charge Voltage Monitor
20 Discharge Circuit
30 Vehicle (Moving Object)
31 Moving Object Body
A1 Amplifier
D2 Diode
P1 Connection Point
R1 Shunt Resistor
R2 Current Restricting Resistor
RT1 First Feed Path
RT2 Second Feed Path
RT11 Charging Path
RT13 Feed Path
SW1 Switch (First Switch)
SW2 Second Switch
TR1 Input Terminal
TR2 Output Terminal
V2 Charge Voltage
Vth Threshold Voltage

1. A charging system comprising:
an input terminal to which a power supply is to be connected;
a charging circuit connected between the input terminal and a power storing apparatus to supply a charge current from the power supply to the power storing apparatus;
a shunt resistor connected to a charging path through which the charge current flows;
an amplifier configured to amplify a voltage across the shunt resistor and output the voltage thus amplified;
a controller configured to control the charging circuit on a basis of an output from the amplifier; and
a power supplying circuit configured to supply a drive voltage to the amplifier,
the power supplying circuit including
a first feed path including a diode connected between the input terminal and a power supply terminal of the amplifier and
a second feed path including a switch connected between the power storing apparatus and the power supply terminal of the amplifier,
the switch being configured to be turned on when a charge voltage of the power storing apparatus exceeds a threshold voltage.

2. The charging system of claim 1, further comprising a current restricting resistor connected in series to the diode in the first feed path.

3. The charging system of claim 1, wherein
the amplifier includes a full-range operational amplifier.

4. The charging system of claim 1, wherein
the charging circuit includes a step-up circuit configured to increase a voltage of the power supply to be supplied to the input terminal, and
the power storing apparatus is configured to be charged with an output from the step-up circuit.

5. The charging system of claim 1, wherein
the threshold voltage is lower than a lower limit value of a voltage variation range when the power supply is in a non-failure state.

6. The charging system of claim 1, further comprising a charge voltage monitor configured to monitor a voltage value of the charge voltage of the power storing apparatus, wherein
the controller is configured to turn on the switch on a basis of a monitoring output from the charge voltage monitor when the charge voltage exceeds the threshold voltage.

7. The charging system of claim 6, wherein
the power supplying circuit is configured to supply the drive voltage also to the charge voltage monitor.

8. A backup power source system comprising:
the charging system of claim 1;
an output terminal to which a load is to be connected; and
a discharge circuit configured to supply electric power from the power storing apparatus via the output terminal to the load when the power supply is in a failure state.

9. The backup power source system of claim 8, further comprising the power storing apparatus.

10. The backup power source system of claim 8, wherein
the switch is a first switch,
the charging circuit includes a second switch connected between the input terminal and the power storing apparatus,
the discharge circuit includes a feed path connecting the output terminal to a connection point between the input terminal and the charging circuit, and
the second switch is shared by the discharge circuit and the charging circuit.

11. A moving object comprising:
the backup power source system of claim 8; and
a moving object body on which the backup power source system, the power supply, and the load are mounted.

12. The charging system of claim 2, wherein
the amplifier includes a full-range operational amplifier.

13. The charging system of claim 2, wherein
the charging circuit includes a step-up circuit configured to increase a voltage of the power supply to be supplied to the input terminal, and
the power storing apparatus is configured to be charged with an output from the step-up circuit.

14. The charging system of claim 3, wherein
the charging circuit includes a step-up circuit configured to increase a voltage of the power supply to be supplied to the input terminal, and
the power storing apparatus is configured to be charged with an output from the step-up circuit.

15. The charging system of claim 2, wherein
the threshold voltage is lower than a lower limit value of a voltage variation range when the power supply is in a non-failure state.

16. The charging system of claim 3, wherein
the threshold voltage is lower than a lower limit value of a voltage variation range when the power supply is in a non-failure state.

17. The charging system of claim 4, wherein
the threshold voltage is lower than a lower limit value of a voltage variation range when the power supply is in a non-failure state.

18. The charging system of claim 2, further comprising a charge voltage monitor configured to monitor a voltage value of the charge voltage of the power storing apparatus, wherein
the controller is configured to turn on the switch on a basis of a monitoring output from the charge voltage monitor when the charge voltage exceeds the threshold voltage.

19. The charging system of claim 3, further comprising a charge voltage monitor configured to monitor a voltage value of the charge voltage of the power storing apparatus, wherein
the controller is configured to turn on the switch on a basis of a monitoring output from the charge voltage monitor when the charge voltage exceeds the threshold voltage.

20. The charging system of claim 4, further comprising a charge voltage monitor configured to monitor a voltage value of the charge voltage of the power storing apparatus, wherein
the controller is configured to turn on the switch on a basis of a monitoring output from the charge voltage monitor when the charge voltage exceeds the threshold voltage.
